(19) United States
(12) Patent Application Publication
(10) Pub. No.: US 2026/0309866 A1
(43) Pub. Date: Oct. 8, 2026

(54) INVERSION METHOD AND SYSTEM FOR HYDRO-THERMAL OF PERMAFROST COUPLED INSAR WITH ERT

(71) Applicant: Institute of Mountain Hazards and Environment, CAS, Chengdu (CN)

(72) Inventors: Qingkai MENG, Chengdu (CN); Qing LI, Chengdu (CN); Shilong CHEN, Chengdu (CN)

(21) Appl. No.: 19/351,757

(22) Filed: Oct. 7, 2025

(30) Foreign Application Priority Data
Apr. 3, 2025 (CN) 202510412921.7

(51) Int. Cl. G01S 13/90; G01S 13/88; G01V 3/08; G06F 17/11

(52) U.S. Cl. CPC G01S 13/9023; G01S 13/885; G01V 3/088; G06F 17/11

(57) ABSTRACT

The present application discloses an inversion method and system for internal hydro-thermal of permafrost coupled InSAR with ERT, relating to the technical field of hydro-thermal properties inversion of permafrost, including: separating freeze-thaw deformation data based on InSAR ground deformation data; determining the depth of dynamic freeze-thaw interface based on multi-temporal ERT data and inverting a first water content; correcting the thickness of active layer in a frost heave theoretical model based on the depth of dynamic freeze-thaw interface to obtain a corrected frost heave model; inverting a second water content from the freeze-thaw deformation data using the corrected frost heave model; optimizing a coupled hydro-thermal numerical model using the first water content; and inputting InSAR ground deformation data and ground temperature into the optimized model to output temperature and a third water content at different periods and depths within the permafrost of the study area.

### CROSS-REFERENCE TO RELATED APPLICATION

This application claims the benefit of Chinese Patent Application No. 202510412921.7, filed on Apr. 3, 2025, which is hereby incorporated by reference in its entirety including any tables, figures, or drawings.

### TECHNICAL FIELD

The present application relates to the technical field of internal hydro-thermal properties of permafrost, and in particular, to an inversion method and system for internal hydro-thermal of permafrost coupled InSAR with ERT.

### BACKGROUND

The internal hydro-thermal properties of permafrost are key factors in understanding the degradation processes of permafrost under climate change and predicting the evolution of permafrost hazards. High-precision inversion of these hydro-thermal properties is of significant importance. Currently, approaches for hydro-thermal inversion primarily include in-situ measurement, model simulation, and satellite remote sensing inversion. In-situ measurement uses equipment such as the borehole thermometer and the time domain reflectometer (TDR) to obtain vertical hydro-thermal profile data of a single-point. While the single-point detection can achieve centimeter-level resolution, obtaining regional data requires dense deployment and significant resource costs Model simulation, primarily based on a principle of conservation of mass and energy, typically employ land process models to simulate energy fluxes across the atmosphere, vegetation, and soil system. While such models can produce hydro-thermal product data above kilometer-level resolution, they suffer from low spatial resolution and long data update cycles, failing to meet application requirements; Satellite remote sensing inversion, such as thermal infrared and passive microwave sensing, offer large-scale ground hydro-thermal monitoring. However, their detection depth is limited to near-ground layers (<10 cm), rendering them completely ineffective for retrieving hydro-thermal properties within an active layer of permafrost (typically 1-3 meters deep). Therefore, there is currently no effective method for accurately acquiring internal hydro-thermal of permafrost at the regional scale.

Given the above challenges, the present application is hereby proposed.

### SUMMARY

The technical problem addressed by the present application lies in the low inversion accuracy and poor universality of existing methods for internal hydro-thermal inversion of permafrost. Accordingly, the objective of the present application is to provide an inversion method and system for internal hydro-thermal of permafrost coupled InSAR with ERT. The method and system utilizes InSAR ground deformation monitoring in conjunction with the frost heave theory to derive water content, and employs ERT electrical resistivity tomography to obtain the vertical electrical resistivity distribution function and dynamic values of freeze-thaw interface depth. A coupled hydro-thermal numerical model considering time-varying characteristics is then constructed. This enables high-precision dynamic inversion of internal hydro-thermal properties of permafrost at the regional scale, thereby providing crucial data and technical solutions for ensuring the safety of permafrost engineering and enabling early warning of permafrost hazards.

Among them, InSAR (Interferometric Synthetic Aperture Radar) refers to interferometric synthetic aperture radar, and ERT (Electrical Resistance Tomography) refers to electrical resistivity tomography.

The present application is realized through the following technical solution:

A first aspect of the present application provides an inversion method for internal hydro-thermal of permafrost coupled InSAR with ERT. The method comprises:
obtaining InSAR ground deformation data, ERT data, and ground temperature from a same study area;
separating freeze-thaw deformation data based on the InSAR ground deformation data using an improved InSAR deformation separation model of permafrost;
determining a depth of dynamic freeze-thaw interface and inverting a first water content based on multi-temporal ERT data;
correcting the thickness of an active layer in a frost heave theoretical model based on the depth of dynamic freeze-thaw interface, thereby obtaining a corrected frost heave theoretical model;
inverting a second water content based on the freeze-thaw deformation data using the corrected frost heave theoretical model;
inputting the second water content and ground temperature as initial conditions, and the depth of dynamic freeze-thaw interface as a boundary condition, into a coupled hydro-thermal numerical model; optimizing the coupled hydro-thermal numerical model using the first water content, thereby obtaining an optimized dynamic coupled hydro-thermal numerical model; and
inputting the InSAR ground deformation data and ground temperature into the optimized dynamic coupled hydro-thermal numerical model, which outputs temperature and a third water content at different periods and depths within the permafrost of the study area.

In some embodiments, the InSAR ground deformation data is obtained by processing SAR imagery data and DEM data using time-series InSAR interferometry;
the ERT data is obtained by deploying an electrical resistivity tomography system in the study area to acquire multi-temporal electrical resistivity profile data ρ(z,t) covering a whole year;
the ground temperature is a time series of land ground temperature data Ts(t) obtained from satellite remote sensing products, meteorological data, or ground-based monitoring stations.

In some embodiments, separating the freeze-thaw deformation data based on the improved InSAR deformation separation model of permafrost comprises:
according to multi-temporal SAR imagery data and DEM data, after image registration and terrain phase removal, interference pairs are selected using the preset temporal baseline and spatial baseline thresholds to generate differential interferograms;
selecting high coherence points based on differential interferograms as target point sets;
performing phase unwrapping on target point sets using a minimum cost flow algorithm to obtain a unwrapped phase;
simulating seasonal phase based on the unwrapped phase and internal hydro-thermal factors, and improving a conventional deformation separation model of permafrost, thereby obtaining the improved InSAR deformation separation model of permafrost;
separating seasonal deformation of permafrost and intrinsic deformation of slope based on the improved InSAR deformation separation model of permafrost, and converting the seasonal deformation of permafrost into the freeze-thaw deformation data.

In some embodiments, the freeze-thaw deformation data is the time-varying ground freeze-thaw deformation displacement d(t) within the study area, wherein d(t)=[d(t₁), d(t₂), . . . , d(t_{N})], t₁~t_{N} represent time series, and d(t_{N}) represents the ground freeze-thaw deformation at time t_{N}.

In some embodiments, determining the depth of dynamic freeze-thaw interface and invert the first water content based on multi-temporal ERT data comprises:
determining the depth of dynamic freeze-thaw interface at different times by identifying electrical resistivity gradient extrema from the multi-temporal ERT data;
and inverting the first water content θ_{ERT}(z,t) at different times and depths by combining Archie's law.

In some embodiments, the second water content is the average soil water content corresponding to the freezing depth or thawing depth.

In some embodiments, inverting the second water content based on the corrected frost heave theoretical model comprises:
the formula for inverting water content during the freezing period is:

$$\overline{θ ( t )} = {θ}_{res} + {k}_{f} \cdot ( {T}_{f} - {T}_{s} ) \cdot \frac{Δ d ( t )}{{Δ z}_{f} ( t )} ;$$

the formula for inverting water content during the thawing period is:

$$\overline{θ ( t )} = \frac{Δ d ( t )}{{Δ z}_{f} ( t ) \cdot \frac{{ρ}_{w} - {ρ}_{i}}{{ρ}_{i}}} ;$$

in the above equation, θ̅(̅t̅)̅ is an average soil water content at time t corresponding to the change in freezing depth or thawing depth Δz_{f}(t), i.e., the second water content; θᵣₑₛ is a residual water content of the soil after freezing; k_{f} is the temperature res correction coefficient; T_{f} is a freezing temperature of soil; Tₛ is a ground temperature; Δd(t) is a freeze-thaw displacement, equal to d(t)−d(t−1), where d(t) is the ground freeze-thaw displacement at time t, and d(t−1) is the freeze-thaw displacement at the previous time t−1; ρᵢ is an electrical resistivity of ice; ρ_{w} is an electrical resistivity of water; Δz_{f}(t) is a variation in the freezing or thawing depth of the soil layer, equal to z_{f}(t)−z_{f}(t−1), where z_{f}(t) is the depth of freeze-thaw interface at time t, and z_{f}(t−1) is the depth of freeze-thaw interface at the previous time t−1, which is derived from the ERT data.

In some embodiments, a process of optimizing the coupled hydro-thermal numerical model comprises:
generating N parameter {p₁, p₂, . . . , p_{N}} sets based on prior parameters; pᵢ=[λₑ, ρcₚ, K_{w}, θᵣₑₛ, α]^{T} is a parameter vector to be optimized, i is a positive integer, λₑ is an effective thermal conductivity of soil, ρcₚ is a volumetric heat capacity of soil, K_{w} is a water permeability, θᵣₑₛ is a residual unfrozen water content, α is an expansion coefficient, [ ]^{T} is the transpose of a vector;
for each parameter set pᵢ, computing a predicted water content value θ_{model}(z, t; pᵢ) at depth z and time t using the coupled hydro-thermal numerical model;
generating an observation vector y_{ERT}=[θ_{ERT}(z₁, t), θ_{ERT} (z₂, t), . . . , θ_{ERT} (zₘ, t)]^{T} from the first water content inverted at time t, wherein θ_{ERT} (zₘ,t) is the first water content at depth zₘ and time t obtained from ERT inversion;
constructing an objective function

$$Γ ( {p}_{i} ) = {\sum }_{t = 1}^{{N}_{t}} {\sum }_{z = 1}^{{N}_{z}} {[ {θ}_{model} ( z , t ; {p}_{i} ) - {θ}_{ERT} ( z , t ) ]}^{2}$$

based on the predicted water content values and the observation vector to compute a global residual sum of squares, wherein Nₜ is a time of observation, N_{z} is a maximum freezing or thawing thickness, and θ_{ERT}(z,t) is the first water content at depth z and time t obtained from ERT inversion; and
based on the global residual sum of squares, a minimum residual is obtained through gradient calculation to update hydro-thermal characteristic parameters, resulting in the optimized dynamic coupled hydro-thermal numerical model.

The above technical solution corrects the predicted water content and optimizes the coupled hydro-thermal numerical model based on the observation vector.

A second aspect of the present application provides an inversion system for internal hydro-thermal of permafrost coupled InSAR with ERT. The system comprises:
an acquisition unit, configured to acquire InSAR ground deformation data, ERT data, and ground temperature from a same study area;
a separation unit, configured to separate freeze-thaw deformation data based on the InSAR ground deformation data using an improved InSAR deformation separation model of permafrost;
a determination unit, configured to determine a depth of dynamic freeze-thaw interface and to invert a first water content based on multi-temporal ERT data;
a correction unit for frost heave model, configured to correct the thickness of an active layer in the frost heave theoretical model based on the depth of dynamic freeze-thaw interface, thereby obtaining a corrected frost heave theoretical model;
an inversion unit for water content, configured to invert a second water content based on the freeze-thaw deformation data using the corrected frost heave theoretical model;
an optimization unit for hydro-thermal model, configured to input the second water content and ground temperature as initial conditions, and the depth of dynamic freeze-thaw interface as a boundary condition, into a coupled hydro-thermal numerical model; and to optimize the coupled hydro-thermal numerical model using the first water content, thereby obtaining an optimized dynamic coupled hydro-thermal numerical model; and
an inversion unit for internal hydro-thermal of permafrost, configured to input InSAR ground deformation data and ground temperature into the optimized dynamic coupled hydro-thermal numerical model, which outputs temperature and a third water content at different periods and depths within the permafrost of the study area.

In some embodiments, the determination unit comprises:
a determination sub-unit, configured to determine the depth of dynamic freeze-thaw interface at different times by identifying electrical resistivity gradient extrema from the multi-temporal ERT data; and
an inversion sub-unit, configured to invert the first water content at different times and depths by combining Archie's law.

Compared with the prior art, the present application offers the following advantages and beneficial effects:
1. The inversion method and system for internal hydro-thermal of permafrost coupled InSAR with ERT, as provided by the present application, utilizes InSAR ground deformation monitoring in conjunction with the frost heave theory to derive water content, and employs ETR electrical resistivity tomography to obtain the vertical electrical resistivity distribution function and values of dynamic freeze-thaw interface depth. The coupled hydro-thermal numerical model considering time-varying characteristics is then constructed. This enables high-precision dynamic inversion of internal hydro-thermal properties of permafrost at the regional scale, thereby providing crucial data and technical solutions for ensuring the safety of permafrost engineering and enabling early warning of permafrost hazards.
2. The present application utilizes high-resolution SAR imagery such as Sentinel-1, LT-1, and GF-3, and through time-series InSAR interferometry, obtains seasonal ground deformation, and then invert water content at high temporal and spatial resolution (≤12 days, ≤30 meters), replacing traditional meteorological station interpolation and conventional remote sensing data.
3. While conventional remote sensing methods are limited to retrieving near-ground water content (<10 cm), the present application integrates InSAR with ERT data to construct the coupled hydro-thermal numerical model considering time-varying characteristics. This model allows for dynamic calibration of the freeze-thaw interface depth z_{f}(t), enabling real-time tracking of permafrost freezing and thawing processes, and dynamically inverting temperature and water content parameters at varying underground depths.
4. Traditional hydro-thermal models typically rely on empirical values for key soil hydro-thermal parameters (e.g., effective thermal conductivity of soil λₑ and volumetric heat capacity of soil ρcₚ). The present application enables the acquisition of high-resolution (<0.1 m) vertical water content through in-situ observation combined with ERT, which optimizes the parameters of traditional coupled hydro-thermal model and further improves model accuracy.
5. The present application integrates multi-source data such as InSAR, ERT, and in-situ observations, combined with time-series analysis and the coupled hydro-thermal numerical model, to provide technical solutions and effective data for inverting underground hydro-thermal fields at the regional level.

### BRIEF DESCRIPTION OF DRAWINGS

The drawings described herein are used to provide further illustrate embodiments of the present application and constitute a part of this application. They are not intended to limit the scope of the embodiments of the application in any way. In the drawings:

FIG. 1 is a flowchart of an inversion method for internal hydro-thermal of permafrost coupled InSAR with ERT according to the present application;

FIG. 2 is a detailed flowchart of the inversion method for internal hydro-thermal of permafrost coupled InSAR with ERT according to the present application;

FIG. 3 is a diagram showing monitoring results of regional ground deformation rates according to the present application;

FIG. 4 is a diagram showing ERT inversion results of water content according to the present application;

FIG. 5 is a diagram showing the inversion of relationship between ground deformation and water content in the region according to the present application;

FIG. 6(a) is a temperature distribution map at a depth of 0.3 m in the region according to the present application;

FIG. 6(b) is a temperature distribution map at a depth of 1 m in the region according to the present application;

FIG. 6(c) is a temperature distribution map at a depth of 2 m in the region according to the present application;

FIG. 6(d) is a temperature distribution map at a depth of 2.5 m in the region according to the present application;

FIG. 7(a) is a water content distribution map at a depth of 0.3 m in the region according to the present application;

FIG. 7(b) is a water content distribution map at a depth of 1 m in the region according to the present application;

FIG. 7(c) is a water content distribution map at a depth of 2 m in the region according to the present application;

FIG. 7(d) is a water content distribution map at a depth of 2.5 m in the region according to the present application;

FIG. 8 is a structural block diagram of an inversion system for internal hydro-thermal of permafrost coupled InSAR with ERT according to the present application.

### DESCRIPTION OF EMBODIMENTS

In order to clarify the objects, aspects, and advantages of the present application, the present disclosure will be further described in detail below in conjunction with specific embodiments with reference to the accompanying drawings. It should be understood that the illustrative embodiments and descriptions thereof are intended solely for explanatory purposes and are not intended to limit the scope of the present application in any way.

The innovation of the present application lies in the coupling of InSAR and ERT technologies to achieve high-precision dynamic inversion of internal hydro-thermal properties of permafrost at the regional scale, thereby providing crucial data and technical solutions for ensuring the safety of permafrost engineering and enabling early warning of permafrost hazards.

First, by leveraging the high temporal and spatial resolution characteristics of time-series InSAR interferometry and the high vertical resolution of ERT, combined with frost heave theory, the application overcomes the limitations of traditional remote sensing in probing underground hydro-thermal conditions. It enables high-precision inversion of underground hydro-thermal fields in multiple dimensions, with temporal resolution ≤12 days, spatial resolution ≤30 meters, and vertical depth up to 3 meters. Specifically, InSAR provides high-resolution ground deformation data, while ERT offers long-term electrical resistivity profiles to determine the depth of dynamic freeze-thaw interface and internal soil water content. Their integration, grounded in frost heave theory, effectively compensates for the lack of vertical distribution detail in traditional remote sensing of soil water content, offering a comprehensive multidimensional profile of permafrost internal water content.

Second, the dynamic update of the freeze-thaw interface depth using ERT addresses the limitations of conventional coupled hydro-thermal numerical models, which suffer from low inversion accuracy and poor generalizability due to unclear internal structures, inaccurate freeze-thaw parameters, and uncertain freeze-thaw interface locations. Specifically, the integration of ERT with the coupled hydro-thermal numerical model enables the introduction of a time-varying function of freeze-thaw interface depth obtained from ERT measurements, thereby correcting conventional hydro-thermal models and improving parameter certainty in hydro-thermal inversion. As a result, the accuracy of underground water content inversion is significantly enhanced.

In this application, multiple SAR images are processed to obtain InSAR ground deformation data. Freeze-thaw deformation data (i.e., ground freeze-thaw deformation) d(t) is separated and, combined with the frost heave theory, is used to invert the corresponding seasonal water content as the initial condition for hydro-thermal coupling. Time-series ERT provides the vertical electrical resistivity distribution function ρ(z,t) and the depth of dynamic freeze-thaw interface z_{f}(t), which is used as the boundary condition for underground hydro-thermal inversion. A coupled hydro-thermal numerical model considering time-varying characteristics is then constructed. A first water content θ_{ERT}(z,t) obtained from ERT measurements during observation periods is used as validation data for the coupled hydro-thermal numerical model parameters. After model optimization, ground temperature and InSAR ground deformation data are input to the model to invert the underground hydro-thermal distribution within the permafrost region, yielding temperature T(z,t) and a third water content θ(z,t).

### Embodiment 1

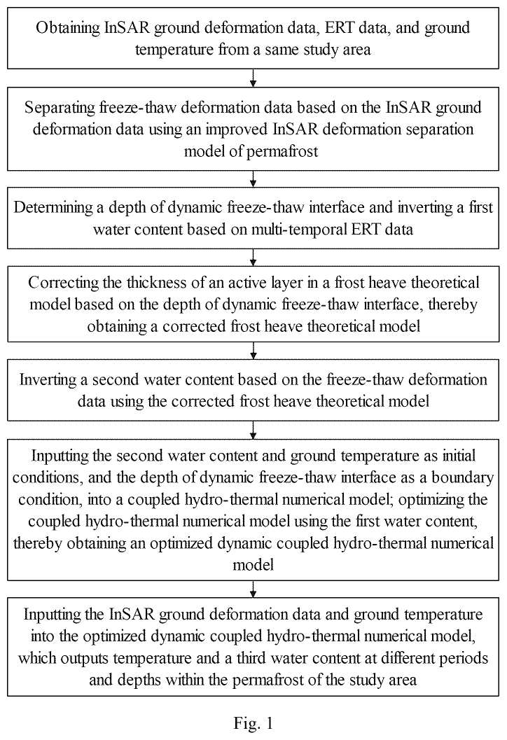

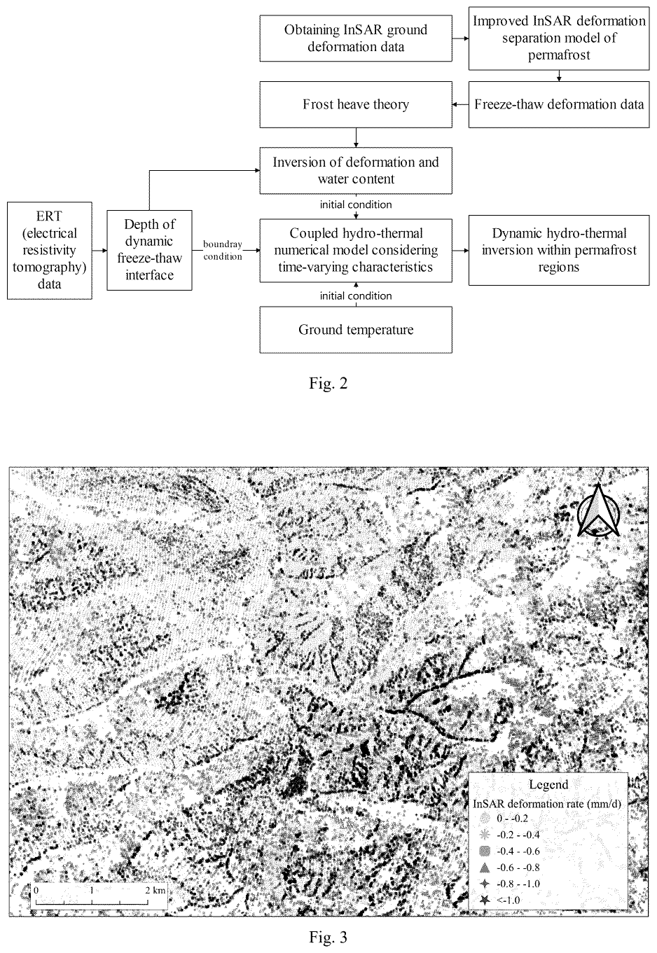

As shown in FIG. 1 and FIG. 2, FIG. 1 is a flowchart of an inversion method for internal hydro-thermal of permafrost coupled InSAR with ERT according to the present application; FIG. 2 is a detailed flowchart of the inversion method for internal hydro-thermal of permafrost coupled InSAR with ERT according to the present application; The inversion method for internal hydro-thermal of permafrost coupled InSAR with ERT comprises the following steps:
S1, obtaining InSAR ground deformation data, ERT data, and ground temperature from a same study area.

Specifically, the InSAR ground deformation data is obtained by processing SAR imagery data and DEM data using time-series InSAR interferometry.

The ERT data is obtained by deploying the electrical resistivity tomography system in the study area to acquire multi-temporal electrical resistivity profile data ρ(z,t) covering a whole year.

The ground temperature is a time series of land ground temperature data Ts(t) obtained from satellite remote sensing products, meteorological data, or ground-based monitoring stations.

In this embodiment, Sentinel-1 SAR imagery covering the study area for the period 2019-2020 and SRTM 30-meter resolution DEM data are used. The time span is selected to fully cover the entire freeze-thaw cycle. Image registration and terrain phase removal are performed to eliminate deformation errors caused by terrain heterogeneity. Accurate co-registration between master and slave images is achieved using a weighted least squares method. The co-registration accuracy is evaluated by the standard deviation of offset dispersion at tie points and is typically less than 0.001 pixels.

An electrical resistivity tomography system was deployed at the same profile within the study area to obtain multi-temporal electrical resistivity profile data covering the whole year (ensuring that the measurement data covers key periods in the freeze-thaw cycle, i.e., the initial stage of freezing, the deepest stage of the freezing interface, the initial stage of thawing, and the maximum thawing period), i.e., ERT data ρ(z,t).

Obtaining ground soil temperature Ts(t) using soil temperature and moisture sensors installed within the study area.
S2, separating freeze-thaw deformation data based on the InSAR ground deformation data using an improved InSAR deformation separation model of permafrost.

Specifically, step S2 comprises:
S21, according to multi-temporal SAR imagery data and DEM data, after image registration and terrain phase removal, interference pairs are selected using the preset temporal baseline and spatial baseline thresholds to generate differential interferograms.
S22, selecting high coherence points based on differential interferograms as target point sets.
S23, performing phase unwrapping on the target point sets using a minimum cost flow algorithm to obtain a unwrapped phase.
S24, simulating seasonal phase based on the unwrapped phase and internal hydro-thermal factors, and improving a conventional deformation separation model of permafrost, thereby obtaining the improved InSAR deformation separation model of permafrost.
S25, separating seasonal deformation of permafrost and intrinsic deformation of slope based on the improved InSAR deformation separation model of permafrost, and converting the seasonal deformation of permafrost into the freeze-thaw deformation data. The freeze-thaw deformation data is a time-varying ground freeze-thaw displacement d(t) within the study area, representing a long-term time-series dataset of ground freeze-thaw deformation, wherein d(t)=[d(t₁), d(t₂), . . . , d(t_{N})], t₁~t_{N} represent the time series, and d(t_{N}) represents the ground freeze-thaw deformation at time t_{N}.

In this embodiment, in step S21, appropriate temporal baseline (≤24 days) and spatial baseline (≤200 m) thresholds are selected to form interferometric pairs, and differential interferograms are generated. In step S22, optimal thresholds are set by analyzing characteristics such as amplitude stability, phase stability, and temporal correlation, and stable high coherence points are selected as target point sets for subsequent phase extraction. In step S23, the minimum cost flow algorithm is used to unwrap and restore the true phase of target point sets, with the formula being:

$$Δφ = {φ}_{top} + {φ}_{atm} + {φ}_{seasonal} + {φ}_{def} + {φ}_{noise} ;$$

In the above equation, Δφ is a unwrapped deformation phase, φₜₒₚ is a phase related to elevation; φₐₜₘ is a phase induced by atmospheric disturbances; φₛₑₐₛₒₙₐₗ is a seasonal deformation of permafrost; φ_{def} is intrinsic deformation driven by gravity; φₙₒᵢₛₑ is other noise.

In step S24, the permafrost deformation separation includes:
(1) Seasonal deformation separation and noise removal;

Considering that permafrost undergoes seasonal settlement and uplift, the permafrost deformation model can be expressed as:

$$Δφ = \frac{4 π}{λ} ( A + {\sum }_{n = 1}^{N} β nBn ( t ) + {φ}_{top} ( Δ h , t ) + {φ}_{atm - h} ( Δ h , t ) + {φ}_{atm - tur} ( t ) + {φ}_{def} ( t ) + {φ}_{noise} ) ;$$

In the above equation, λ is a radar wavelength; Δh is a height difference; φₐₜₘ₋ₕ and φₐₜₘ₋ₜᵤᵣ represent atmospheric components of height and turbulent path delay caused by complex mountain effects, which are related to changes in the propagation path of the radar signal as it traverses the atmosphere. These components are removed through spatial and temporal filtering; φₜₒₚ(Δh,t) is an elevation phase at time t related to Δh; φₐₜₘ₋ₕ(Δh,t) is an atmospheric phase at time t related to Δh; Δφₐₜₘ₋ₜᵤᵣ(t) is a turbulent path delay atmospheric component at time t; φₙₒᵢₛₑ is removed through spatial filtering; φ_{def}(t) is a slope deformation component at a specific time t; A is a phase constant; N is a number of internal environmental factors; βn is a coefficient related to internal environmental factors (n=1, 2, 3, . . . ); Bn(t) is a phase at time t in different interferograms. Based on measured data, the parameters affecting permafrost deformation are soil temperature and humidity, so N=2. After noise removal, the phase can be expressed as:

$$Δφ = \frac{4 π}{λ} ( A + β1 B 1 ( t ) + β2 B 2 ( t ) + {φ}_{def} ( t ) ) ;$$

In the above equation, β1 is a correlation coefficient of internal environmental factor 1, and B1(t) is a phase of internal environmental factor 1 at time t; β2 is a correlation coefficient of internal environmental factor 2, and B2(t) is a phase of internal environmental factor 2 at time t;
(2) Phase conversion and solution;

Substitute an unknown parameter matrix Z=[A, β1, β2, φ_{def}] into a regression equation and solve the following matrix equation set:

$$BZ = Δφ ;$$

$$Z = {( {B}^{T} B )}^{- 1} {B}^{T} Δφ ;$$

where B is a matrix defining the combination of small baseline interferograms. An unique solution can be obtained using the singular value decomposition (SVD). The inversion accuracy is assessed by phase residuals, yielding φₛₑₐₛₒₙₐₗ for seasonal deformation of permafrost and φ_{def} for self-deformation driven by gravity. Finally, the φₛₑₐₛₒₙₐₗ phase information is converted into the freeze-thaw displacement, yielding the time-varying ground freeze-thaw displacement d(t) within the target region. FIG. 3 is the monitoring results of regional ground deformation rates from February to April 2020, with deformation rates expressed in mm/d (millimeters per day), and “-” indicating thaw subsidence.
S3, determining a depth of dynamic freeze-thaw interface and inverting a first water content based on multi-temporal ERT data.

Specifically, determining the depth of dynamic freeze-thaw interface and invert the first water content based on multi-temporal ERT data comprises:

Determining the dynamic depth of freeze-thaw interface at different times by identifying electrical resistivity gradient extrema from the multi-temporal ERT data.

And inverting the first water content θ_{ERT}(z,t) at different times and depths by combining Archie's law.

In this embodiment, step S3 comprises:
(1) Dynamic calibration of the depth of dynamic freeze-thaw interface.

For each ERT data ρ(z,tₖ), the vertical electrical resistivity gradient at depth z and time tₖ is calculated using the following equation, where z is the depth and Δz is the depth step size.

$$g ( z , {t}_{k} ) = \frac{\partial ρ ( z , {t}_{k} )}{\partial z} \approx \frac{ρ ( z + Δ z , {t}_{k} ) - ρ ( z - Δ z , {t}_{k} )}{2 Δ z} ;$$

In the above equation, ρ(z,tₖ) is an electrical resistivity at depth z and time tₖ, ρ(z+Δz, tₖ) is an electrical resistivity at depth z+Δz and time tₖ, and ρ(z−Δz, tₖ) is an electrical resistivity at depthz−Δz and time tₖ;

The freeze-thaw interface depth z_{f}(tₖ) at time tₖ is the point of maximum electrical resistivity gradient. The depth of dynamic freeze-thaw interface over time is obtained using the following equation:

$${z}_{f} ( {t}_{k} ) = arg {max}_{z} \vert g ( z , {t}_{k} ) \vert ;$$

When T(z_{f},tₖ)>T_{f} (T_{f} is a freezing temperature of soil), a corrected freeze-thaw interface depth

$${z}_{f}^{new}$$

is:

$${z}_{f}^{new} = {z}_{f} + \frac{T ( {z}_{f} , {t}_{k} ) - {T}_{f}}{∇ T} , ( ∇ T = \frac{\partial T}{\partial z} ) ;$$

In the above equation, Z_{f} is the freeze-thaw interface depth; T(z_{f}, tₖ) is a temperature at depth z_{f} and time tₖ; ∇T is a temperature gradient; T is the temperature; z is the depth;

$$\frac{\partial T}{\partial z}$$

is a variation of temperature with depth;

$${z}_{f}^{new}$$

is the corrected freeze-thaw interface depth.

### (2) Water Content Inversion Based on an Archie Model.

Based on the Archie's law, combined with the dynamic depth of freeze-thaw interface, a relationship between resistivity and water content within the frozen soil is constructed:

In an unfrozen zone, the soil mainly contains liquid water and has good conductivity. The relationship between resistivity and water content is:

$${θ}_{ERT} ( z , t ) = ϕ ( z ) \cdot {( \frac{{a}_{s} \cdot {ρ}_{w}}{ρ ( z , t ) \cdot {ϕ ( z )}^{m}} )}^{1 / s} ( the unfrozen zone ) ;$$

In the above equation, φ(z) is a soil porosity at depth z, z is the depth; ρ_{w} is an electrical resistivity of water; αₛ is an empirical coefficient reflecting soil particle characteristics; m is a porosity index; s is a soil saturation; and ρ(z,t) is an electrical resistivity at depth z and time t.

In a frozen zone, the relationship between electrical resistivity and unfrozen water content is:

$${θ}_{ERT} ( z , t ) = {θ}_{res} + \frac{ln ( {ρ}_{i} / ρ ( z , t ) )}{η} ( the frozen zone ) ;$$

In the above equation, ρᵢ is an electrical resistivity of ice, res is a residual water content after soil freezing, and n is an unfrozen water influence coefficient.

### (3) Parameter Optimization

In the representative monitoring section, layered soil temperature and humidity sensors are deployed to obtain in-situ measurements of soil temperature and humidity, denoted as Tₛₑₙₛₒᵣ(z,t) and θₛₑₙₛₒᵣ(z,t), respectively. Using methods such as the least squares method, the electrical resistivity and water content inversion parameters aₛ, m and s are determined, and an electrical resistivity inversion water content distribution map for the typical area is generated.

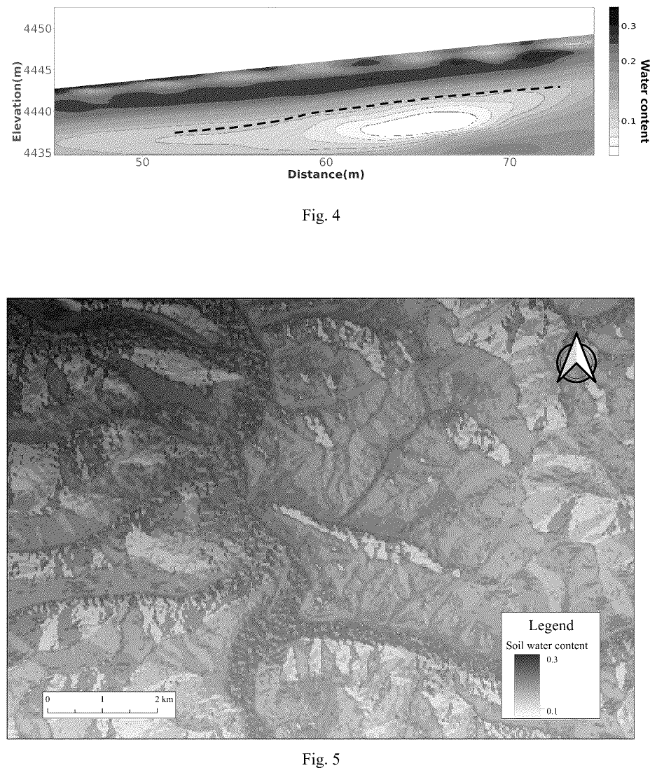

As shown in FIG. 4, this is the ERT inversion water content result map for a specific period during permafrost thawing. In this embodiment, aₛ=0.4~0.6, m=1, φ=0.5~0.6 and s=3. The current freeze-thaw interface position z_{f} is determined from the ERT detection results, as indicated by the red dashed line in FIG. 4.
S4, correcting the thickness of an active layer in a frost heave theoretical model based on the depth of dynamic freeze-thaw interface, thereby obtaining a corrected frost heave theoretical model;

In this embodiment, considering that InSAR seasonal deformation is affected by the internal structure of permafrost and the depth of the freeze-thaw interface, the depth of the dynamic freeze-thaw interface measured by ERT is introduced to correct the thickness of the active layer in the frost heave theoretical model.
S5, inverting a second water content based on the freeze-thaw deformation data using the corrected frost heave theoretical model;

Specifically, the second water content refers to an average soil water content corresponding to the freezing depth or thawing depth.

In this embodiment, the ground freeze-thaw deformation d(t) is primarily caused by the expansion due to water freezing or subsidence due to thawing within the soil. The deformation is related to the thickness of freezing or thawing layer and the water content. Considering the differences in heat conduction during freezing and thawing processes in permafrost, where freezing involves unidirectional downward heat transfer from the ground, and thawing involves bidirectional heat transfer from both the ground and underground toward the center, the depth of freeze-thaw interface z_{f}(t) obtained from in-situ ERT observation is introduced. Accordingly, during the freezing or thawing period, the average soil water content θ̅(̅t̅)̅ associated with the change in freezing or thawing thickness Δz_{f}(t) at time t can be expressed as the following equation:

The formula for inverting water content during the freezing period is:

$$\overline{θ ( t )} = {θ}_{res} + {k}_{f} \cdot ( {T}_{f} - {T}_{s} ) \cdot \frac{Δ d ( t )}{Δ {z}_{f} ( t )} ;$$

The formula for inverting water content during the thawing period is:

$$\overline{θ ( t )} = \frac{Δ d ( t )}{Δ {z}_{f} ( t ) \cdot \frac{{ρ}_{w} - {ρ}_{t}}{{ρ}_{i}}} ;$$

In the above equation, θ̅(̅t̅)̅ is an average soil water content at time t corresponding to the change in freezing depth or thawing depth Δz_{f}(t), i.e., the second water content; θᵣₑₛ is a residual water content of the soil after freezing; k_{f} is a temperature correction coefficient; T_{f} is a freezing temperature of soil; Tₛ is a ground temperature; Δd(t) s is the freeze-thaw displacement, equal to d(t)−d(t−1), where d(t) is the ground freeze-thaw displacement at time t, and d(t−1) is the freeze-thaw displacement at the previous time t−1; ρᵢ is an electrical resistivity of ice; ρ_{w} is an electrical resistivity of water; Δz_{f}(t) is a variation in the freezing or thawing depth of the soil layer, equal to z_{f}(t)−z_{f}(t−1), where z_{f}(t) is the depth of freeze-thaw interface at time t, and z_{f}(t−1) is the depth of freeze-thaw interface at the previous time t−1, which is derived from the ERT data;

$$\frac{{ρ}_{w}}{{ρ}_{i}}$$

is a density ratio between water and ice, with a value of 1.09.

Based on the previously obtained regional InSAR ground deformation data, the relationship between regional deformation coefficient and water content derived, as shown in FIG. 5. The water content referred to here corresponds to the second water content.
S6, inputting the second water content and ground temperature as initial conditions, and the depth of dynamic freeze-thaw interface as a boundary condition, into a coupled hydro-thermal numerical model; optimizing the coupled hydro-thermal numerical model using the first water content, thereby obtaining an optimized dynamic coupled hydro-thermal numerical model. The initial water content is obtained from the water content inferred based on the InSAR ground deformation data.

Specifically, the temperature gradient changes within permafrost follows the law of heat conduction, and water migration follows Darcy's law. The coupled hydro-thermal numerical model considering time-varying characteristics is constructed by incorporating the dynamic freeze-thaw interface obtained from ERT. Inputting the initial water content and ground temperature obtained from InSAR deformation observations as initial conditions, and the depth of dynamic freeze-thaw interface observed by ERT as a boundary condition, into the coupled hydro-thermal numerical model.

The first water content θ_{ERT}(z,t) inverted from ERT is used to optimize model parameters (such as thermal conductivity k, water diffusivity coefficient D, and expansion coefficient α), through iterative computation to obtain the optimal hydro-thermal numerical solution. Specifically:
(1) Establishment of the coupled hydro-thermal numerical model considering time-varying characteristics.

In permafrost, the water content is not statically distributed. During the freezing and thawing process, phase changes occur between liquid water and ice, accompanied by the release or absorption of latent heat. Additionally, the depth of freeze-thaw interface z is not fixed but varies dynamically over time. Based on these considerations, an improved coupled hydro-thermal numerical model is established as follows:

### Heat Conduction Equation:

$$ρ {c}_{p} \frac{\partial T ( z , t )}{\partial t} = ∇ ( {λ}_{e} ∇ T ( z , t ) ) + {L}_{f} {ρ}_{i} \frac{\partial {θ}_{i} ( z , t )}{\partial t} ;$$

### Water Migration Equation:

$$\frac{\partial θ ( z , t )}{\partial t} = ∇ \cdot ( {K}_{w} ∇ θ ( z , t ) ) + \frac{\partial {K}_{w}}{\partial z} + {S}_{phase} ( z , t ) ;$$

### Latent Heat Flux Due to Phase Change:

$${L}_{f} {ρ}_{i} \frac{{dz}_{f} ( t )}{dt} = {[ {λ}_{f} \frac{\partial {T}_{f}}{\partial z} - {λ}_{u} \frac{\partial {T}_{u}}{\partial z} ]}_{z = {z}_{f} ( t )} ;$$

In the above equations, λₑ is an effective thermal conductivity of soil, ρcₚ is a volumetric heat capacity of soil, L_{f} is a latent heat of phase change between water and ice, θᵢ is a ice volume fraction, K_{w} is a water permeability, related to soil type and temperature; λ_{f} and λᵤ are thermal conductivities in the frozen and unfrozen zones, respectively; Tᵤ is a temperature of the unfrozen zone, Sₚₕₐₛₑ(z,t) is a water source term, including precipitation, evaporation and other factors;

$$\frac{\partial ( )}{\partial }$$

is a derivation of partial differential, ∇( ) is a gradient solution; T(z,t) is a temperature at depth z and time t, θᵢ(z,t) is an ice volume fraction at depth z and time t; θ(z,t) is a water content at depth z and time t; z_{f}(t) is the depth of freeze-thaw interface at time t;
(2) Determination of the boundary conditions for the equation.

The upper boundary is the ground layer (z=0), satisfying T(0,t)=Tₛ(t) T(0,t) is a ground temperature at time t; Tₛ(t) is a ground temperature obtained from sensors, weather stations or other monitoring sources;

The average water content θ̅(̅t̅)̅ corresponding to a melting depth Δz_{f}(t) at time t is obtained in step S5;

At the freeze-thaw interface z_{f}:

$${T ( {z}_{f} , t ) = {T}_{f} , \frac{\partial θ ( z , t )}{\partial z} \vert}_{z \to {z}_{f}} = 0.$$

(3) Optimization of parameters for hydro-thermal coupling processes.

Specifically, the optimization steps of the coupled hydro-thermal numerical model comprise:

Generating N parameter sets {p₁, p₂, . . . p_{N}} based on prior parameters (the effective thermal conductivity of soil λₑ, volumetric heat capacity of soil ρcₚ, the water permeability K_{w}, the residual unfrozen water content θᵣₑₛ, the expansion coefficient α);
pᵢ=[λₑ, ρcₚ, K_{w}, θᵣₑₛ, α]^{T} is a parameter vector to be optimized, i is a positive integer, [ ]^{T} is a transpose of the vector.

For each parameter set pᵢ, computing a predicted water content value θ_{model} (z, t; pᵢ) at depth z and time t using the coupled hydro-thermal numerical model.

Generating an observation vector y_{ERT}=[θ_{ERT}(z₁, t), θ_{ERT} (z₂, t), . . . , θ_{ERT} (zₘ, t)]^{T} from the first water content inverted at time t, wherein θ_{ERT} (zₘ,t) is the first water content at depth zₘ and time t obtained from ERT inversion.

Constructing an objective function

$$Γ ( {p}_{i} ) = {{\sum }_{t = 1}}^{{N}_{t}} {{\sum }_{z = 1}}^{{N}_{z}} {[ {θ}_{model} ( z , t ; {p}_{i} ) - {θ}_{ERT} ( z , t ) ]}^{2}$$

based on the predicted water content values and the observation vector to compute a global residual sum of squares, wherein Nₜ is a time of observation, N_{z} is a maximum freezing or thawing thickness, and θ_{ERT}(z,t) is the first water content at depth z and time t obtained from ERT inversion.

Based on the global residual sum of squares, a minimum residual is obtained through gradient calculation to update the hydro-thermal characteristic parameters, resulting in the optimized dynamic coupled hydro-thermal numerical model.

The above technical solution corrects the predicted water content based on the observation vector and optimizes the coupled hydro-thermal numerical model.
S7, inputting the InSAR ground deformation data and ground temperature into the optimized dynamic coupled hydro-thermal numerical model, which outputs temperature T(z,t) and a third water content θ(z,t) at different periods and depths within the permafrost of the study area.

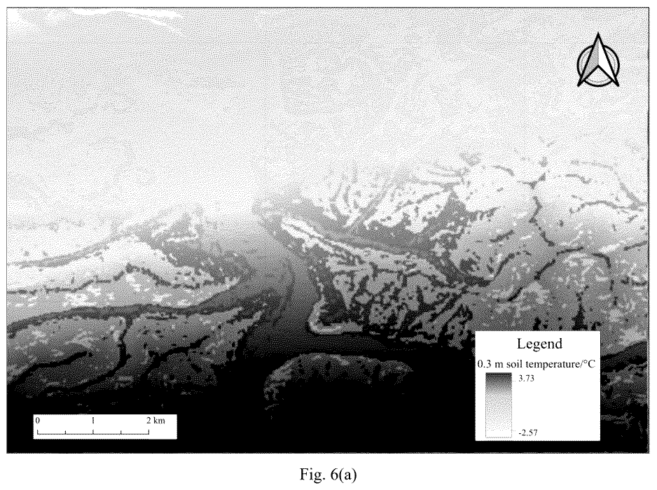

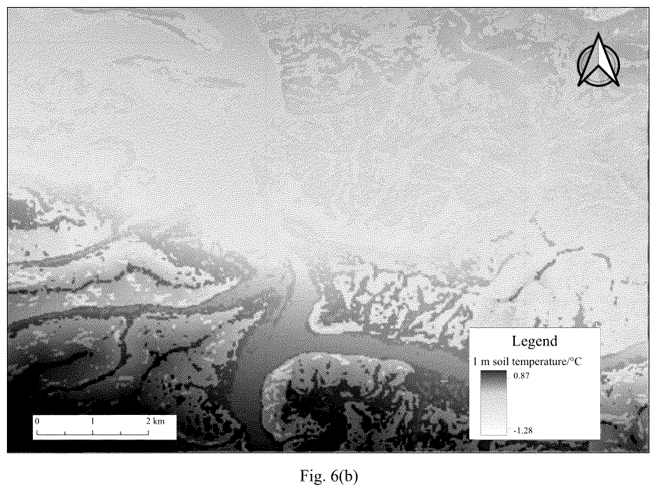

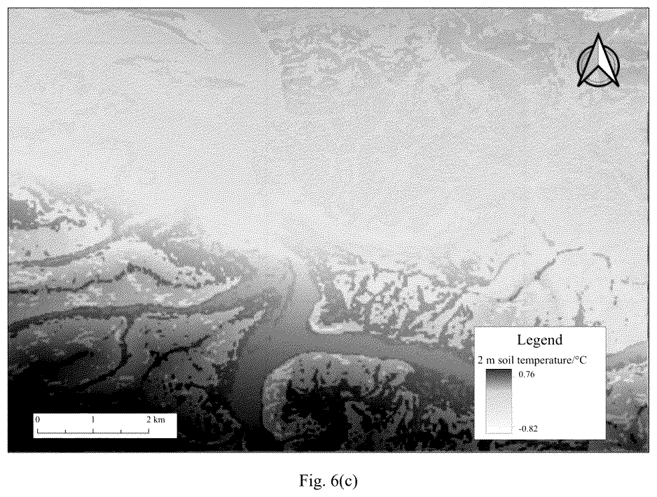

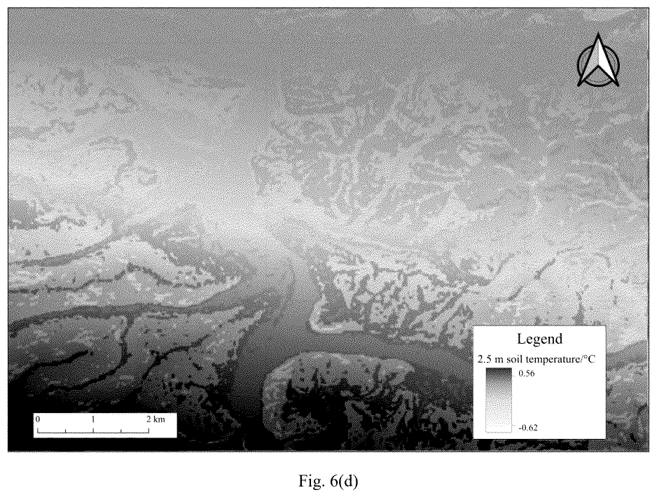

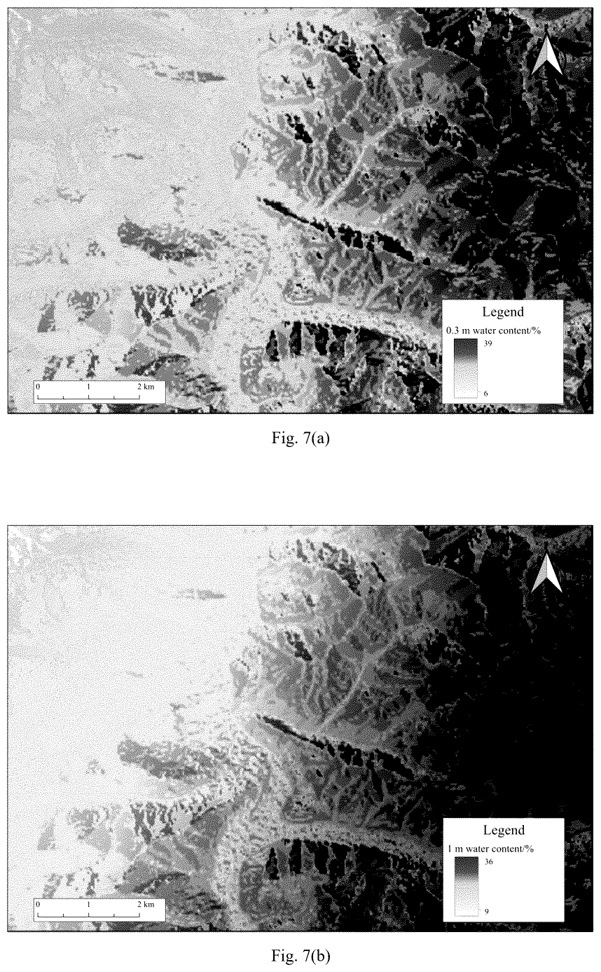

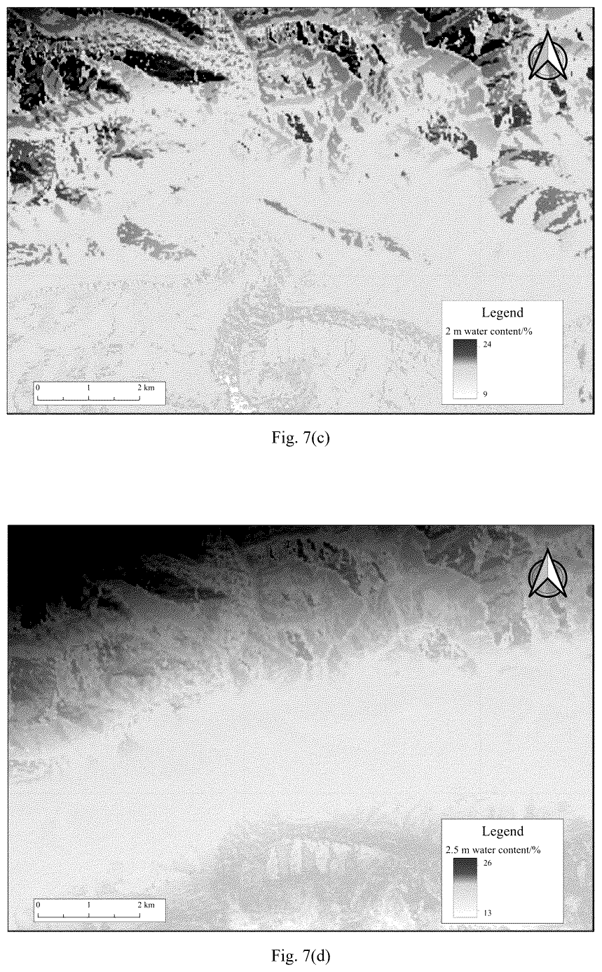

In this embodiment, the optimized dynamic coupled hydro-thermal numerical model is used. Based on the premise that the internal structure of the regional permafrost is consistent, InSAR ground deformation data and ground temperature are input to obtain the temperature T(z,t) and third water content θ(z,t) at different depths and times within the regional permafrost. As shown in FIG. 6(a)-FIG. 6(d) and FIG. 7(a)-FIG. 7(d), these figures illustrate the internal spatial distribution of hydro-thermal content obtained through the aforementioned steps, demonstrating that this method enables real-time tracking of the permafrost freezing and thawing processes and dynamic inversion of underground temperature and water content at different depths within the region, providing an effective solution for inverting internal hydro-thermal field at the regional scale.

### Embodiment 2

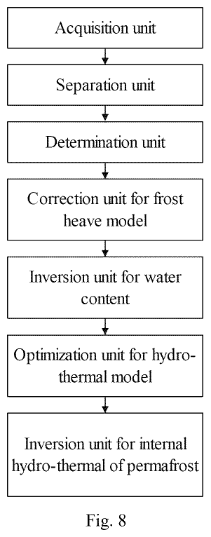

As shown in FIG. 8, the difference between this embodiment and embodiment 1 lies in that the present embodiment provides an inversion system for internal hydro-thermal of permafrost coupled InSAR with ERT, which corresponds one-to-one with the inversion method for internal hydro-thermal of permafrost coupled InSAR with ERT described in embodiment 1.

The system comprises:
An acquisition unit, configured to acquire InSAR ground deformation data, ERT data, and ground temperature from a same study area.
A separation unit, configured to separate freeze-thaw deformation data based on the InSAR ground deformation data using an improved InSAR deformation separation model of permafrost.
A determination unit, configured to determine a depth of dynamic freeze-thaw interface and to invert a first water content based on multi-temporal ERT data.
A correction unit for frost heave model, configured to correct thickness of an active layer in the frost heave theoretical model based on the depth of dynamic freeze-thaw interface, thereby obtaining a corrected frost heave theoretical model.
An inversion unit for water content, configured to invert a second water content based on the freeze-thaw deformation data using the corrected frost heave theoretical model.
An optimization unit for hydro-thermal model, configured to input the second water content and ground temperature as initial conditions, and the depth of dynamic freeze-thaw interface as a boundary condition, into a coupled hydro-thermal numerical model; and to optimize the coupled hydro-thermal numerical model using the first water content, thereby obtaining an optimized dynamic coupled hydro-thermal numerical model.
An inversion unit for internal hydro-thermal of permafrost, configured to input InSAR ground deformation data and ground temperature into the optimized dynamic coupled hydro-thermal numerical model, which outputs temperature T(z,t) and a third water content θ(z,t) at different periods and depths within the permafrost of the study area.

In this embodiment, the determination unit comprises:
A determination sub-unit, configured to determine the depth of dynamic freeze-thaw interface at different times by identifying electrical resistivity gradient extrema from the multi-temporal ERT data.
An inversion sub-unit, configured to invert the first water content θ_{ERT}(z,t) at different times and depths by combining Archie's law.
The execution processes of each unit correspond to the procedural steps of the inversion method for internal hydro-thermal of permafrost coupled InSAR with ERT as described in embodiment 1, and are therefore not repeated herein.

It should be understood by those skilled in the art that the embodiments of the present application may be provided as a method, a system, or a computer program product. Therefore, the present application may take the form of an entirely hardware embodiment, an entirely software embodiment, or an embodiment combining software and hardware aspects. Furthermore, the present application may take the form of a computer program product embodied in one or more computer-readable storage media having computer-readable program code embodied thereon. The computer-readable storage medium may include, but is not limited to, magnetic disk, CD-ROM, optical storage device, or any other storage medium that can store computer-readable program code.

The present application has been described with reference to flowcharts and/or block diagrams of methods, apparatuses (systems), and computer program products according to embodiments of the application. It should be understood that each block of the flowcharts and/or block diagrams, and combinations of blocks in the flowcharts and/or block diagrams, can be implemented by computer program instructions. These computer program instructions may be provided to a general-purpose computer, a special-purpose computer, an embedded processor, or other programmable data processing apparatus to produce a machine, such that the instructions executed by the computer or other programmable data processing apparatus create means for implementing the functions specified in the flowchart and/or block diagram block(s).

These computer program instructions may also be stored in a computer-readable storage medium that can direct a computer or other programmable data processing apparatus to function in a particular manner, such that the instructions stored in the computer-readable medium produce an article of manufacture including instruction means which implement the function specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart and/or block diagram block(s).

It may be understood that the above implementations are only exemplary implementations for illustrating the principles of the present disclosure, but the present disclosure is not limited to these. For the skilled in the art, various variations and improvements may be made without being apart from the sprit and substance of the present disclosure, which also fall into the protection scope of the present disclosure.

What is claimed is:

1. An inversion method for internal hydro-thermal of permafrost coupled InSAR with ERT, comprising:
obtaining InSAR ground deformation data, ERT data, and ground temperature from a same study area;
separating freeze-thaw deformation data based on the InSAR ground deformation data using an improved InSAR deformation separation model of permafrost;
determining a depth of dynamic freeze-thaw interface and inverting a first water content based on multi-temporal ERT data;
correcting the thickness of an active layer in a frost heave theoretical model based on the depth of dynamic freeze-thaw interface, thereby obtaining a corrected frost heave theoretical model;
inverting a second water content based on the freeze-thaw deformation data using the corrected frost heave theoretical model;
inputting the second water content and ground temperature as initial conditions, and the depth of dynamic freeze-thaw interface as a boundary condition, into a coupled hydro-thermal numerical model; optimizing the coupled hydro-thermal numerical model using the first water content, thereby obtaining an optimized dynamic coupled hydro-thermal numerical model; and
inputting the InSAR ground deformation data and ground temperature into the optimized dynamic coupled hydro-thermal numerical model, which outputs temperature and a third water content at different periods and depths within the permafrost of the study area:
wherein optimizing the coupled hydro-thermal numerical model comprises:
generating N parameter sets {p₁, p₂, . . . p_{N}} based on prior parameters;
pᵢ=[λₑ, ρcₚ, K_{w}, θᵣₑₛ, α]^{T} is a parameter vector to be optimized, i is a positive integer, λₑ is an effective thermal conductivity of soil, ρcₚ is a volumetric heat capacity of soil, K_{w} is a water permeability, θᵣₑₛ is a residual unfrozen water content, α is an expansion coefficient, [ ]^{T} is the transpose of a vector;
for each parameter set pᵢ, computing a predicted water content value θ_{model} (z, t; pᵢ) at depth z and time t using the coupled hydro-thermal numerical model;
generating an observation vector y_{ERT}=[θ_{ERT}(z₁, t), θ_{ERT}(z₂, t), . . . , θ_{ERT}(zₘ, t)]^{T} from the first water content inverted at time t, wherein θ_{ERT}(zₘ, t) is the first water content at depth zₘ and time t obtained from ERT inversion;
constructing an objective function
$$Γ ( {p}_{i} ) = {{\sum }_{t = 1}}^{{N}_{t}} {{\sum }_{z = 1}}^{{N}_{z}} {[ {θ}_{model} ( z , t ; {p}_{i} ) - {θ}_{E R T} ( z , t ) ]}^{2}$$
based on the predicted water content values and the observation vector to compute a global residual sum of squares, wherein Nₜ is a time of observation, N_{z} is a maximum freezing or thawing thickness, and θ_{ERT}(z,t) is the first water content at depth z and time t obtained from ERT inversion; and
based on the global residual sum of squares, obtaining a minimum residual through gradient calculation to update hydro-thermal characteristic parameters, resulting in the optimized dynamic coupled hydro-thermal numerical model.

2. The inversion method for internal hydro-thermal of permafrost coupled InSAR with ERT according to claim 1, wherein the InSAR ground deformation data is obtained by processing SAR imagery data and DEM data using time-series InSAR interferometry;
the ERT data is obtained by deploying an electrical resistivity tomography system in the study area to acquire multi-temporal electrical resistivity profile data covering a whole year; and
the ground temperature is a time-series data of ground temperature obtained from satellite remote sensing products, meteorological data, or ground-based monitoring stations.

3. The inversion method for internal hydro-thermal of permafrost coupled InSAR with ERT according to claim 1, wherein separating the freeze-thaw deformation data based on the improved InSAR deformation separation model of permafrost comprises:
according to multi-temporal SAR imagery data and DEM data, after image registration and terrain phase removal, interference pairs are selected using the preset temporal baseline and spatial baseline thresholds to generate differential interferograms;
selecting high coherence points based on differential interferograms as target point sets;
performing phase unwrapping on target point sets using a minimum cost flow algorithm to obtain a unwrapped phase;
simulating seasonal phase based on the unwrapped phase and internal hydro-thermal factors, and improving a conventional deformation separation model of permafrost, thereby obtaining the improved InSAR deformation separation model of permafrost;
separating seasonal deformation of permafrost and intrinsic deformation of slope based on the improved InSAR deformation separation model of permafrost, and converting the seasonal deformation of permafrost into the freeze-thaw deformation data.

4. The inversion method for internal hydro-thermal of permafrost coupled InSAR with ERT according to claim 3, wherein the freeze-thaw deformation data is the time-varying ground freeze-thaw displacement d(t) within the study area, wherein d(t)=[d(t₁), d(t₂), . . . , d(t_{N})], t₁~t_{N} represent time series, and d(t_{N}) represents the ground freeze-thaw displacement at time t_{N}.

5. The inversion method for internal hydro-thermal of permafrost coupled InSAR with ERT according to claim 1, wherein determining the depth of dynamic freeze-thaw interface and inverting the first water content based on multi-temporal ERT data comprises:
determining the depth of dynamic freeze-thaw interface at different times by identifying electrical resistivity gradient extrema from the multi-temporal ERT data;
and inverting the first water content at different times and depths by combining Archie's law.

6. The inversion method for internal hydro-thermal of permafrost coupled InSAR with ERT according to claim 1, wherein the second water content is the average soil water content corresponding to the freezing depth or thawing depth.

7. The inversion method for internal hydro-thermal of permafrost coupled InSAR with ERT according to claim 6, wherein inverting the second water content based on the corrected frost heave theoretical model comprises:
using the following formula for inverting water content during the freezing period:
$$\overline{θ ( t )} = {θ}_{res} + {k}_{f} \cdot ( {T}_{f} - {T}_{s} ) \cdot \frac{Δ d ( t )}{Δ {z}_{f} ( t )} ;$$
and
using the following formula for inverting water content during the thawing period:
$$\overline{θ ( t )} = \frac{Δ d ( t )}{Δ {z}_{f} ( t ) \cdot \frac{{ρ}_{w} - {ρ}_{w}}{{ρ}_{i}}} ;$$
wherein in the above equation, θ̅(̅t̅)̅ is an average soil water content at time t corresponding to the change in freezing depth Δz_{f}(t), i.e., the second water content θᵣₑₛ is a residual water content of the soil after freezing; k_{f} is the temperature correction coefficient; T_{f} is a freezing temperature of soil; Tₛ is a ground temperature; Δd(t) is a freeze-thaw displacement, equal to d(t)−d(t−1), where d(t) is the ground freeze-thaw displacement at time t, and d(t−1) is the freeze-thaw displacement at the previous time t−1; ρᵢ is an electrical resistivity of ice; ρ_{w} is an electrical resistivity of water; Δz_{f}(t) is a variation in the freezing or thawing depth of the soil layer, equal to z_{f}(t)−z_{f}(t−1), where z_{f}(t) is the depth of freeze-thaw interface at time t, and z_{f}(t−1) is the depth of freeze-thaw interface at the previous time t−1, which is derived from the ERT data.

8. An inversion system for internal hydro-thermal of permafrost coupled InSAR with ERT, comprising:
an acquisition unit, configured to acquire InSAR ground deformation data, ERT data, and ground temperature from a same study area;
a separation unit, configured to separate freeze-thaw deformation data based on the InSAR ground deformation data using an improved InSAR deformation separation model of permafrost;
a determination unit, configured to determine a depth of dynamic freeze-thaw interface and to invert a first water content based on multi-temporal ERT data;
a correction unit for frost heave model, configured to correct thickness of an active layer in the frost heave theoretical model based on the depth of dynamic freeze-thaw interface, thereby obtaining a corrected frost heave theoretical model;
an inversion unit for water content, configured to invert a second water content based on the freeze-thaw deformation data using the corrected frost heave theoretical model;
an optimization unit for hydro-thermal model, configured to input the second water content and ground temperature as initial conditions, and the depth of dynamic freeze-thaw interface as a boundary condition, into a coupled hydro-thermal numerical model; and to optimize the coupled hydro-thermal numerical model using the first water content, thereby obtaining an optimized dynamic coupled hydro-thermal numerical model; and
an inversion unit for internal hydro-thermal of permafrost, configured to input InSAR ground deformation data and ground temperature into the optimized dynamic coupled hydro-thermal numerical model, which outputs temperature and a third water content at different periods and depths within the permafrost of the study area;
wherein a process of optimizing the coupled hydro-thermal numerical model comprises:
generating N parameter {p₁, p₂, . . . p_{N}} sets based on prior parameters; pᵢ=[λₑ, ρcₚ, K_{w}, θᵣₑₛ, α]^{T} is a parameter vector to be optimized, i is a positive integer, λₑ is an effective thermal conductivity of soil, ρcₚ is a volumetric heat capacity of soil, K_{w} is a water permeability, θᵣₑₛ is a residual unfrozen water content, α is an expansion coefficient, [ ]^{T} is the transpose of a vector;
for each parameter set pᵢ, computing a predicted water content value θ_{model}(z, t; pᵢ) at depth z and time t using the coupled hydro-thermal numerical model;
generating an observation vector y_{ERT}=[θ_{ERT}(z₁, t), θ_{ERT}(z₂, t), . . . , θ_{ERT}(zₘ, t)]^{T} from the first water content inverted at time t, wherein θ_{ERT}(zₘ, t) is the first water content at depth zₘ and time t obtained from ERT inversion;
constructing an objective function
$$Γ ( {p}_{i} ) = {{\sum }_{t = 1}}^{{N}_{t}} {{\sum }_{z = 1}}^{{N}_{z}} {[ {θ}_{model} ( z , t ; {p}_{i} ) - {θ}_{ERT} ( z , t ) ]}^{2}$$
based on the predicted water content values and the observation vector to compute a global residual sum of squares, wherein Nₜ is a time of observation, N_{z} is a maximum freezing or thawing thickness, and θ_{ERT}(z,t) is the first water content at depth z and time t obtained from ERT inversion; and
based on the global residual sum of squares, a minimum residual is obtained through gradient calculation to update hydro-thermal characteristic parameters, resulting in the optimized dynamic coupled hydro-thermal numerical model.

9. The inversion system for internal hydro-thermal of permafrost coupled InSAR with ERT according to claim 8, wherein the determination unit comprises:
a determination sub-unit, configured to determine the depth of dynamic freeze-thaw interface at different times by identifying electrical resistivity gradient extrema from the multi-temporal ERT data; and
an inversion sub-unit, configured to invert the first water content at different times and depths by combining Archie's law.
